(19) United States
(12) Patent Application Publication
(10) Pub. No.: US 2013/0297603 A1
(43) Pub. Date: Nov. 7, 2013

(54) MONITORING METHODS AND SYSTEMS FOR DATA CENTERS

(71) Applicants: Fritz Brenker, Paderborn (DE); Michael Burnicki, Bad Lippspringe (DE); Patrick Kaspari, Lichtenau (DE); Oliver Niehörster, Paderborn (DE); Ulrich Recker, Rietberg (DE)

(72) Inventors: Fritz Brenker, Paderborn (DE); Michael Burnicki, Bad Lippspringe (DE); Patrick Kaspari, Lichtenau (DE); Oliver Niehörster, Paderborn (DE); Ulrich Recker, Rietberg (DE)

(73) Assignee: Fujitsu Technology Solutions Intellectual Property GmbH, Munchen (DE)

(21) Appl. No.: 13/461,140

(22) Filed: May 1, 2012

(51) Int. Cl. G06F 17/30

(52) U.S. Cl. 707/737; 707/E17.046

(57) ABSTRACT

A monitoring system includes a database storing configuration information about a plurality of objects in the data center; a first inventory instance that adds a first object to the database, where the first inventory instance classifies the first object based on a set of classification rules to select a set of monitoring rules for the first object based on its classification and add configuration information about the first object to the configuration database; and a first monitoring instance to monitor the first object, the monitoring instance monitoring status of the first object based on respective configuration information in the database; at least one of the first inventory instance and the first monitoring instance identifying a further object functionally connected to the first object, the further objects added to the database by the first or a second inventory instance and monitored by the first or a second monitoring instance.

### TECHNICAL FIELD

This disclosure relates to systems and methods for monitoring objects of data centers. In particular, it relates to monitoring systems and autonomous monitoring methods for use in enterprise IT management (EITM).

### BACKGROUND

As electronic data processing and information technology (IT) becomes ubiquitous, ensuring smooth operation of data centers becomes more important for many businesses. In particular medium to large enterprises, having multiple branches at various locations, often depend on the operation of one or several data centers to implement many of their essential business processes. While the reliability of IT products in general has greatly improved, the complexity and interconnection of various IT components has also grown considerably. Therefore, a failure of one IT component often results in a failure of entire systems or subsystems within a data center, thus causing considerable economical damage to an enterprise.

In this context, it has become important to quickly identify and react to problems arising from failures of individual components of a data center. A plurality of both vendor-specific and vendor independent hardware and software solutions for monitoring data centers exits.

One example of such a system is the so-called “Nagios® XI” system which provides an IT infrastructure monitoring and alerting system. The Nagios® system provides monitoring of infrastructure components—including applications, services, operating systems, network protocols, system matrix and network infrastructure. The Nagios® system monitors an IT infrastructure to ensure that systems, applications, services and business processes are functioning properly. In the event of a failure, the Nagios® system can alert technical staff of a problem.

Furthermore, the open source monitoring tool Icinga provides another monitoring tool, with similar capabilities as the Nagios® system described above. The Icinga system has a modular architecture comprising a core component, a web interface, a database as well as other plug-ins and add-ons. These communicate via an abstraction layer and plug-in API which mediate between external data and internal structures. As a result, the Icinga system can be distributed for redundant monitoring.

While these and similar systems provide powerful monitoring capabilities, at least in some instance, they are difficult to set up and configure. In particular, in large enterprises comprising one or several data centers distributed over one or a plurality of locations and comprising a great number of IT components, manual installation and setup of an IT monitoring system can be both error-prone and prohibitively expensive. Therefore, there is a need for improved monitoring systems and methods for monitoring data centers.

### SUMMARY

We provide monitoring systems for data centers. The monitoring system may comprise a configuration database for storing configuration information about the plurality of objects provided in the data center and at least one first inventory instance for adding at least one first object to the configuration database, wherein the first inventory instance is adapted to classify the first object based on a set of classification rules, select a set of monitoring rules for the first object based on its classification and add configuration information about the first object to the configuration database. The monitoring system further may comprise at least one first monitoring instance for status monitoring of the first object, wherein the first monitoring instance is adapted to monitor the status of the first object based on respective configuration information stored in the configuration database. At least one of the first inventory instance and the first monitoring instance may be adapted to identify at least one further object functionally connected to the first object, the further object being added to the configuration database by the first or a second inventory instance and monitored by the first or a second monitoring instance.

A monitoring system as described above allows both central and distributed management, configuration and an inventory of objects in a data center. Changes to the data center can be detected autonomously, thus allowing generation of a global view of the entire data center. This is of particular advantage in both distributed and dynamic data centers where resources become available and unavailable dynamically based, for example, on demand or an interconnection between different data centers. An example of such a dynamic resource may be a cloud service provided by one or several remote data centers.

Preferably, different views of different perspectives, for example, a network perspective and a business perspective can be provided for the monitored data center.

Furthermore, the provision of different inventory instances and/or monitoring instances can provide, amongst others, redundancy, distribution and the generation of a partial view of the overall view of the monitored data center.

We also provide methods for autonomously monitoring data centers. The method may comprise the following steps:
a) adding at least one first object to a set of objects to be monitored,
b) classifying the at least one first object based on a set of classification rules,
c) selecting a set of monitoring rules for the at least one object based on its classification,
d) monitoring the status of the least one first object based on the selected set of monitoring rules, and
e) identifying at least one further object functionally connected to the first object and recursively repeating steps a) to e) for any further identified object.

A method comprising the steps identified above allows the manual addition or automatic detection of objects of a data center for the purpose of automatic monitoring. Each newly added object is classified such that monitoring based on appropriate monitoring rules for the added object can be implemented automatically or semi-automatically.

The methods and systems described allow for monitoring of different types of objects. Examples of such objects are hardware modules, server computers, network components and network topologies, memory and storage subsystems, software components and business processes.

### BRIEF DESCRIPTION OF THE DRAWINGS

Our systems and methods will be described in more detail with respect to different, currently preferred representative examples described below and shown in the attached figures.

FIG. 1 shows a control circuit for autonomously monitoring a data center implemented by portions of different systems and methods for monitoring.

FIG. 2 shows an interaction between a management interface, a configuration database and a plug-in component.

FIG. 3 shows a more detailed view of an architecture of a system for monitoring a data center.

FIG. 4 shows import and export functions of a product configuration database.

FIG. 5 shows different methods for propagating status changes in a monitoring system.

FIGS. 6A and 6B show different views of a user interface of an example of the monitoring system.

FIG. 7 shows a flowchart of a method for autonomously monitoring a data center.

### DETAILED DESCRIPTION

It will be appreciated that the following description is intended to refer to specific examples of structure selected for illustration in the drawings and is not intended to define or limit the disclosure, other than in the appended claims.

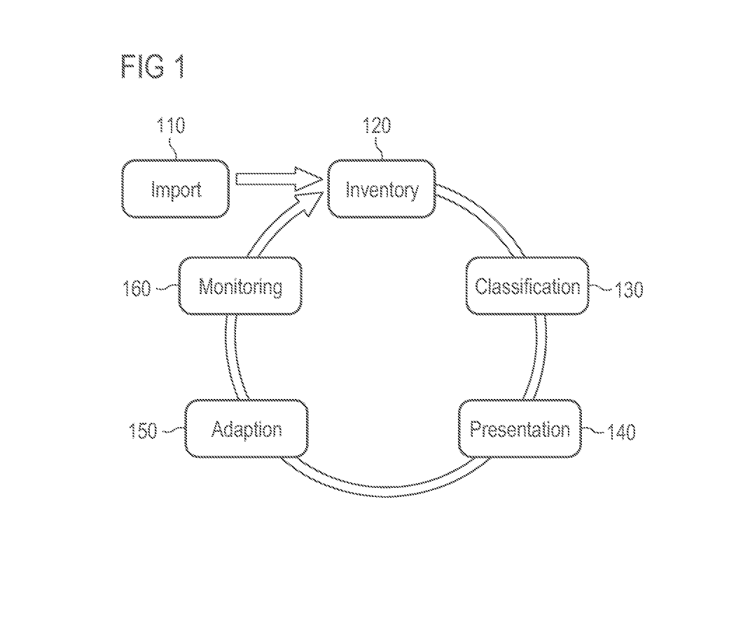

We discovered, among other things, that information obtained by monitoring one or several objects of a data center can be used to obtain information about other components of the data center. Furthermore, such information can be used to configure a monitoring system dynamically. Accordingly, FIG. 1 shows a control cycle implemented by various examples of our systems and methods.

In a first step 110, information about one, several or all objects comprised in a data center are imported. In particular, in step 110, data identifying one or several objects such as hardware components, server computers, network components, network topologies, memory subsystems, storage subsystems, software components and business processes may be provided by a user interface or may be imported from another enterprise IT management system. For example, information provided in a configuration management database (CMDB) of a monitoring system used previously or in parallel to the described system can be imported. Alternatively, a user may manually provide information such as a network address, in particular an IP address, a name and a function of an object within a data center. Of course, also automatic discovery mechanisms such as port or address scans, information provided by system management components or plug-and-play mechanisms may be used to identify new objects.

In a further step 120, the information about the objects imported in step 110 is integrated into an inventory. For example, address information provided about an object may be stored in a configuration management database. Preferably, a relational or object relational database is used to store information related to the identified object. However, other forms of inventories such as structured and unstructured files or other types of databases may also be used.

In a subsequent step 130, the one or more objects added to the inventory in step 120 are classified. The classification can be based on classification rules. Such rules can comprise, for example, automatic classification of objects based on their address, name or functionality. The respective data may be automatically detected in step 130 or provided during the step 110 of importing. For example, a server identified based on an IP address provided in step 110 can be classified as a web server based on a port scan in step 130. Those skilled in the art will understand that many different types and methods of classification are known. For example, physical hardware components often provide a management interface for providing manufacturer and model information that can be used for classification. In addition, software components often provide application programmer interfaces (API) to provide details about services provided and so on. Often, even relatively simple classification rules such as a classification based on a name or network address of a component may be sufficient to detect, for example, a network topology.

In a step 140, the objects of the data center stored in the inventory in step 120 and classified in step 130 are presented at a user interface. For example, a network topology of servers and other network components identified can be presented. The presentation may be provided by a special purpose management tool having a graphical and/or textual user interface or may be provided in the form of a view provided by a web component that can be accessed by a conventional web browser. If the objects presented are connected by a hierarchical structure, for example, the members of work group or the components of a subnet, an appropriate hierarchical representation such as a tree view can be used. Together with a representation of the object itself, for example, its network address or name, a status of the object may be presented. For example, network components or computers working properly can be presented in green. Network components or other objects still working, but reporting one or several warning messages can be presented in yellow. Objects of the data center not responding or reporting a fundamental error can be presented in red.

In an optional step 150, the monitoring rules provided automatically in step 130 can be adapted. For this purpose, the presentation as used in step 140 or a special purpose interface for adapting monitoring rules can be provided. For example, a time interval at which the response of a given web server is monitored using the “ping” command of the IP protocol stack can be provided. Other monitoring parameters that can be used and set to a specific threshold may include network bandwidths, computing capabilities, service availability and others. The possibility to manually adapt automatically provided monitoring parameters allows a user specific configuration of complex monitoring functions provided in a data center. In addition or alternatively, each object may adapt its own rules based on monitored values and the states of other objects contained in the data center. For example, thresholds for monitoring power consumption parameters may be adapted in accordance with the operational state of a server computer.

In a step 160, the objects contained in the inventory are monitored by a central or several distributed monitoring instances. Depending on the type of object, a monitor may be provided in hardware or software. For example, server computers often comprise dedicated monitoring components such as a baseboard management controller (BMC) or management unit (MMU). Other objects such as software threads can be observed using software components such as APIs and the like. On top of monitoring conventional parameters such as the operating states of the objects to be monitored, the step of monitoring 160 also can include monitoring objects for potentially related objects. For example, if the operation of a network component such as a switch or a router is monitored in step 160, the monitoring also includes automatic detection of further network components connected to the network component. As another example, monitoring an operating system provided on a specific computer may also comprise automated monitoring of services provided by individual threads running under that operating system. If any object is identified in step 160, which is not already included in the inventory generated in step 120, the control circuit continues with step 120 with addition of the newly identified object to the inventory.

As is seen from the circular representation of FIG. 1, the method described above implements a closed control cycle which allows the automatic and autonomous monitoring of related objects comprised in a distributed data network. For example, if an operator wishes to generate a view with regard to a specific business function, he or she only needs to provide particulars of a single or few components associated with that particular business process. The monitoring cycle including the steps 120 to 160 will then identify further components also associated with the particular business process and generate an appropriate view of that business process for monitoring.

Due to the relatively abstract definition of the monitored objects, they do not need to represent local resources. Instead, the monitoring system and process described may also be used by service providers having no or only limited hardware resources of their own, but relying on externally provided resources. In this and similar situations, the monitoring service provided allows the monitoring of agreed service level objectives (SLO).

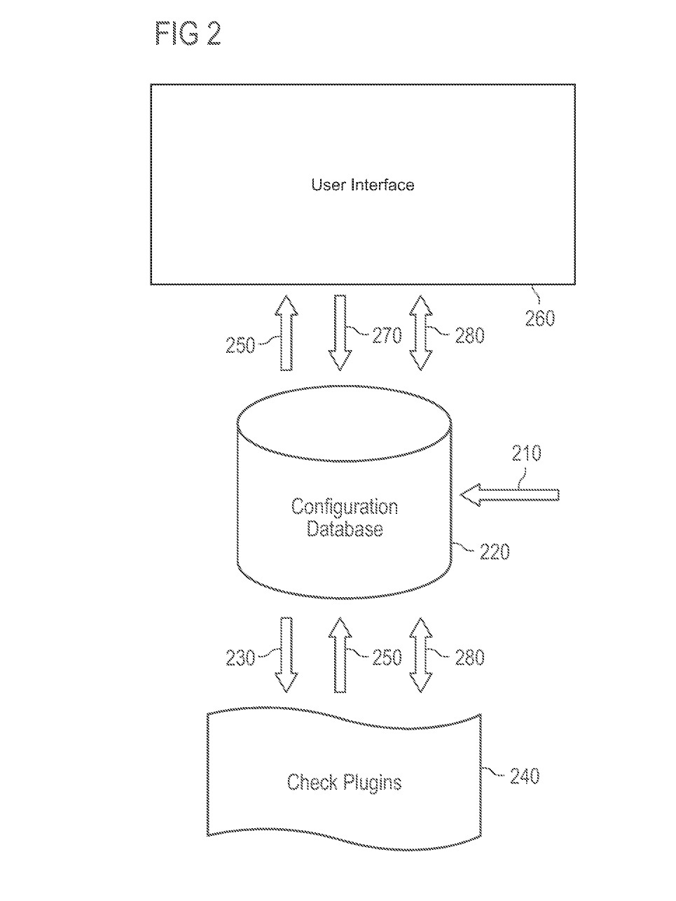

FIG. 2 shows another representation of an autonomous monitoring method.

In a first step 210, a new object such as a system, a subcomponent, a group, a service view and so on, is added to a monitoring system by entering respective data to a configuration database 220.

In a second step 230, an automated classification based on a so-called “check plug-in” 240 is performed. The classification by the check plug-in 240 includes the assignment and scheduling of associated monitoring rules.

In a step 250, the monitoring rules assigned and scheduled by the check plug-in 240 are stored in the configuration database 220 and also used for visualization of the object added in step 210 using a user interface 260. At this stage, further objects functionally connected to the first object may also be detected by the check plug-in 240 and entered into the configuration database 220.

Initially, monitor rules used to monitor an object comprise monitoring attributes and best practice values provided by the check plug-in 240. In a step 270, the provided monitoring rules and best practice values may be changed by the graphical user interface 260. Accordingly, the information stored in the configuration database 220 is updated.

In a continuous step 280, ongoing monitoring of the object provided in step 210 is performed. During monitoring, the check plug-in 240 may further identify objects functionally connected to the monitored object by an automated inventory function. The status of monitored objects is continuously propagated to the configuration database 220 and presented at the graphical user interface 260.

The solution shown in FIGS. 1 and 2 thus reduces administrative efforts by combining reliable mechanisms to monitor objects of a data center with at least some of the method steps as shown explained with reference to FIG. 2 and/or the automated control cycle as described with reference to FIG. 1.

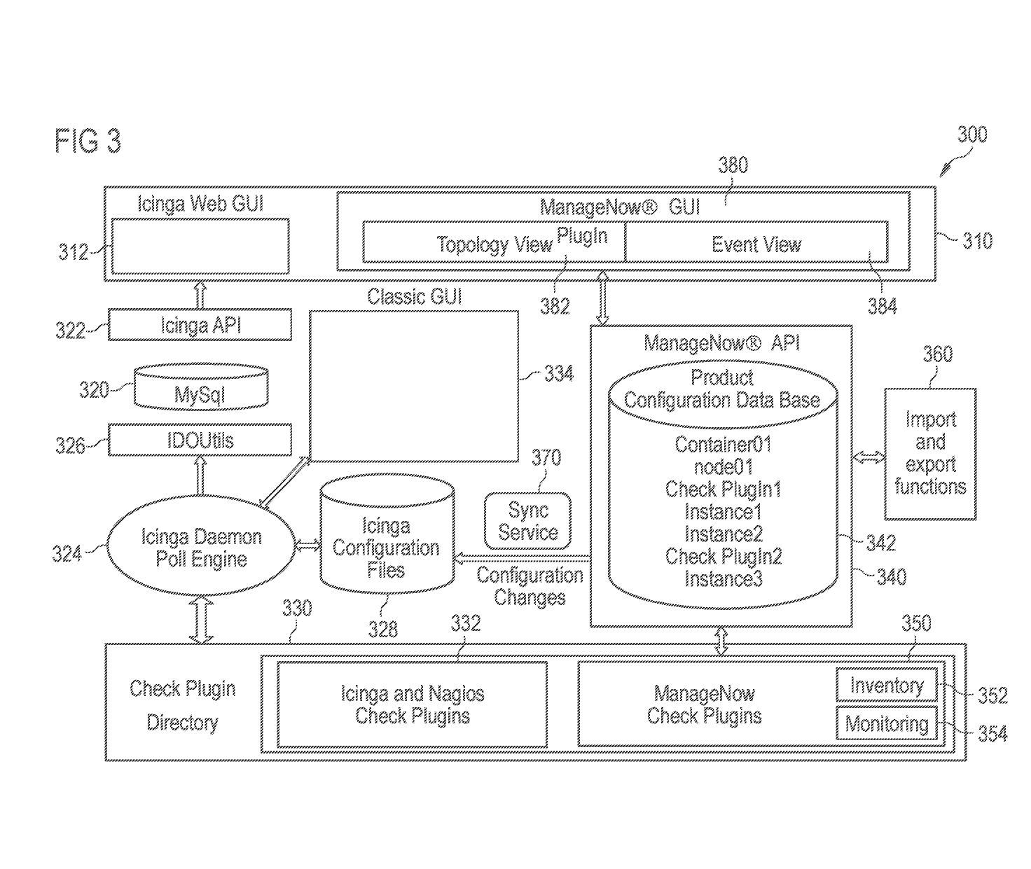

FIG. 3 shows a more detailed schematic diagram of an architecture of a monitoring system 300.

The monitoring system 300 comprises a user interface 310 comprising a conventional web interface 312. The conventional web user interface 312 obtains information from a first monitoring database 320 by a first application programming interface (API) 322. The monitoring database 320 essentially comprises status information obtained from monitored objects. For example, the monitoring database 320 may comprise information about an available network bandwidth, processing power, memory capacity, a list of running processes and other information for predefined time intervals such as for every second, minute or hour of operation of the data center. Alternatively or in addition, the monitoring database 320 may also comprise information typically found in so-called “log files,” i.e. information provided on occurrence of a particular event such as a warning or fault generated by a software component monitored.

Information contained in the monitoring database 320 is provided by a poll engine 324 by a second interface 326. For this purpose, the poll engine 324 polls values of monitored object attributes at regular time intervals from objects of a data center. The current values for monitoring are provided by different check plug-ins 332 installed in a check plug-in directory 330. Different hardware and software components can be used to provide the required data values. In particular, agents such as general purpose agents in accordance with the simple network management protocol (SNMP) or check agents specific to the monitoring system 300 and communicating with the plug-ins by means of the transmission control protocol (TCP) may be used.

Attributes to be monitored as well as the schedule for polling can be viewed and configured by a user interface 334 for local inspection and administration of the poll engine 324. Objects to be monitored, as well as further configuration information such as the schedule for polling the monitored parameters, are stored persistently by a first configuration database 328.

As shown in FIG. 3, the components 312, 320, 322, 324, 326, 328, 332 and 334 make use of the Icinga monitoring system. Of course, other monitoring systems and tools may be used to monitor the status of the objects to be monitored. Furthermore, the monitoring functionality described above may also be provided directly by the further components of the enhanced monitoring system described below.

One substantial advantage of our monitoring system 300 over the known Icinga monitor system is the automatic or semiautomatic provision of configuration data to the first configuration database 328. Another substantial advantage is generation of different views on all or selected subsets of objects of a data center. For this purpose, the monitoring system 300 shown in FIG. 3 comprises a number of further components such as an enhanced API 340, enhanced check plug-ins 350 as well as import and export functions 360 and a synchronization service 370 and an enhanced graphical user interface 380.

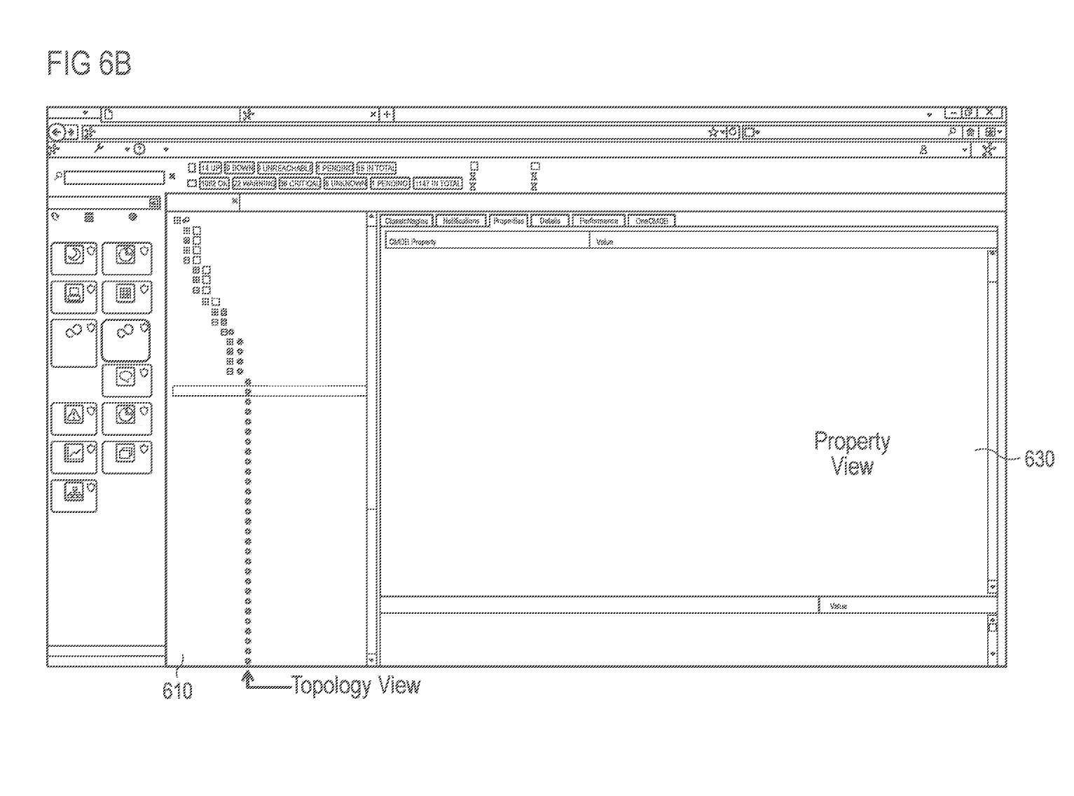

The enhanced graphical user interface 380 provides for generation of different views of the data provided by the enhanced API. The views are implemented by plug-ins. In the example shown in FIG. 3, a first plug-in 382 provides a so-called “topology” view. A second plug-in 384 provides a so-called “event” view. Other plug-ins that display information provided and/or parameters used by the monitoring system 300 may be provided. Examples of possible views include a notification view, a property view, a documentation view, a performance view and a state view. Examples of such views are described later with respect to FIGS. 6A to 6D.

The enhanced API 340 is central to the monitoring system 300 and allows access to a second configuration database 342. In the second configuration database 342 information about all objects monitored by the monitoring system 300 are stored. Apart from information identifying physical objects such as server computers, network components and installed software products, the second configuration database 342 also comprises information about logical groupings of objects as well as business specific views of the objects. Furthermore, the second configuration database 342 comprises information associating each object to be monitored with one or more enhanced check plug-ins 350. Based on information stored in the database 342, the enhanced graphical user interface 312 may provide different views of the monitored data center by the plug-ins 382 and 384.

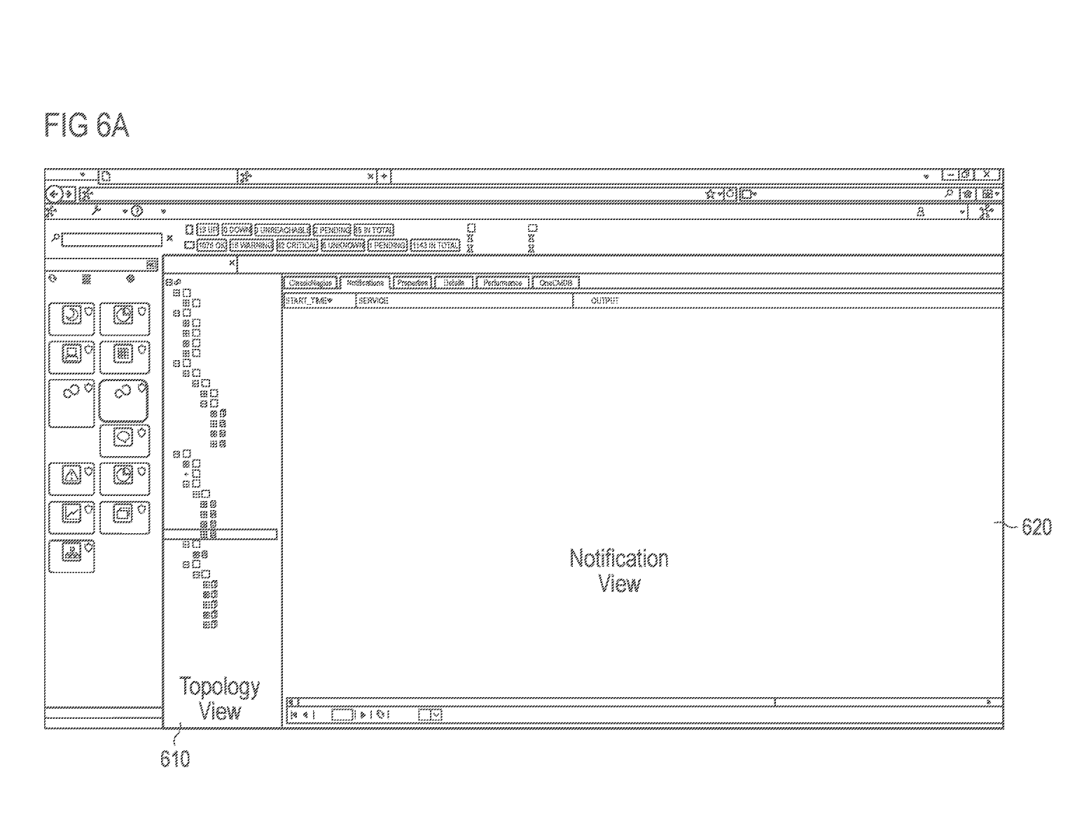

The data contained in the second configuration database 342 is provided, at least in part, by the enhanced check plug-ins 350. For this purpose, the enhanced check plug-in 350 comprises an inventory instance 352 and a monitoring instance 354. The monitoring instance 354 may essentially work like the conventional check plug-ins 332 described above. It provides, for one or several objects of the data center, current values for a parameter to be monitored. In addition, the monitoring instances 354 may also consider information provided by related objects for determining aggregated status information. In this way, the existence and status of connected objects may also be monitored. This feature will be described later with respect to FIG. 5.

The inventory instance 352, on the other hand, provides automatic classification and discovery of objects imported into the database 342, for example, by the import function 360. For example, for a server with a given address, an inventory instance 352 might discover the type of the server provided as well as any sub-object related to the object under investigation. The object hierarchy used in the example is shown, for example, in the topology view 610 of FIGS. 6A and 6B. As can be seen in FIG. 3, the enhanced check plug-ins 350 are also installed in the check plug-in directory 330.

Based on the information provided by the import function 360 as well as the additional information provided by the inventory instance 352 and/or the monitoring instance 354 of the check plug-in 350 associated with objects to be monitored, configuration changes of the data center can be provided by the synchronization service 370 to the first configuration database 328. In this way, objects of a data center discovered by the enhanced monitoring system 300 may be conveniently monitored based on the conventional poll engine 324.

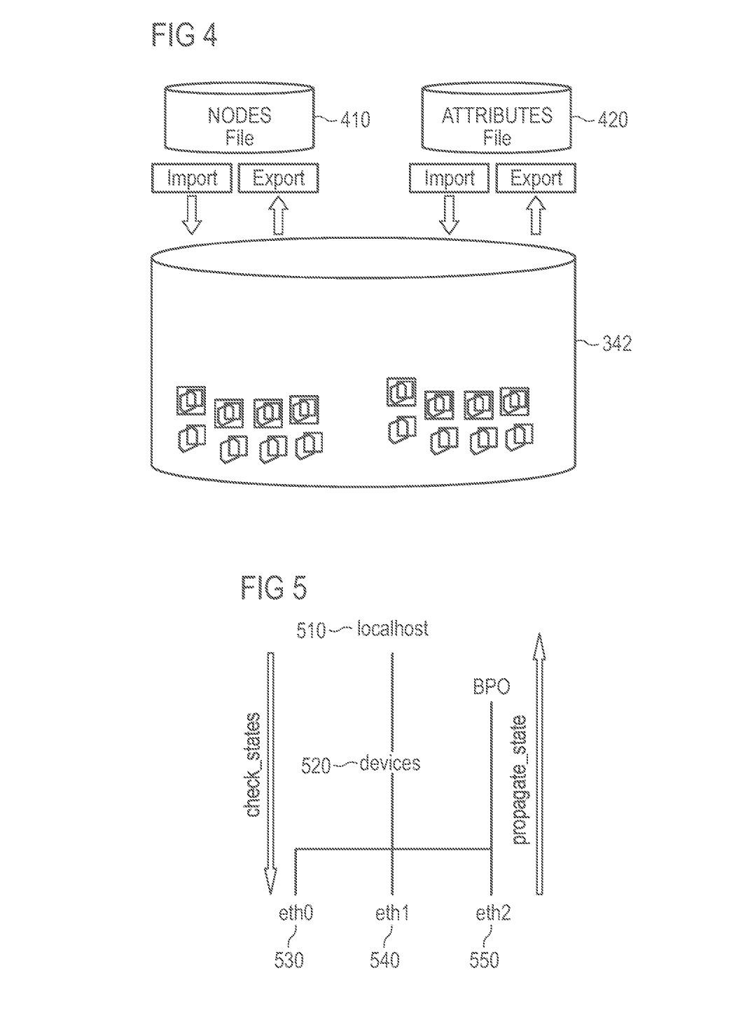

FIG. 4 shows the import and export function 360 in more detail. In particular, the import and export function 360 allows importing to and exporting of node files 410 and attribute files 420 from the second configuration database 342. A node file 410 comprises data about properties that define an object uniquely. For example a node file 410 may comprise the address, the name and the template for a specific object of the monitored data center. For example, a node file may comprise an IP address, a server name and the operating system type of a server. Based on such information, certain standard views can be generated automatically. For example, a network can be browsed based on network addresses or subnets or on server platforms. These views are referred to as topology views and shown in FIG. 6A, for example.

An attribute file 420 comprises data about all other properties of a monitored object, in particular relations known with respect to the object. For example, an attribute file 420 comprises an alias, a monitoring attribute and a value for an object of the configuration database 342 as shown, for example, in FIG. 6B. The individual monitoring parameters can be configured and respective values stored with the attribute files 420.

Based on relationship information provided in the second configuration database 342, aggregated status information about monitored objects can be provided. This feature is of particular use for objects such as logical server, process or business groups which remain operational even if some of their associated physical or logical sub-components fail.

FIG. 5 shows propagation of monitoring parameters between different check plug-ins 350. In the example shown in FIG. 5, a check plug-in provided for a server computer 510, identified as “local host,” determines the states of its subcomponents to update its own monitoring state. In the case of a monitored server computer 510, the subcomponents are represented by devices such as network devices. In the example shown in FIG. 5, the level of devices represents a logical grouping 520 of physical devices 530, 540 and 550, named “eth0” to “eth2,” respectively. These correspond, for example, to different physical network adapters installed in the monitored server computer 510. In a similar way as described with reference to the provision of monitoring rules, rules for propagation may be either provided based on default best practice values, user input or based on automatic discovery. The monitoring rules themselves may also be updated dynamically based on the observed state of the associated object or objects connected to it.

Each object such as the devices 530, 540 and 540, may monitor its own status by one or more associated monitoring instance 352. If a change in its status is detected, this status change is propagated upwardly, i.e. to all objects depending on the status of the monitored object. For example, if one of the Ethernet interfaces devices 530, 540 or 550 fails, this status change is propagated first to the device group 520 and, if configured accordingly, to the server computer 510. For example, the device group 520 may be configured to propagate a status change if two out of three of the Ethernet interfaces devices 530, 540 and 550 fail to inform the monitoring instance 354 of the sever computer 510 that the majority of the Ethernet interface devices 530, 540 and 550 have failed. Inversely, the device group 520 may be configured not to propagate the failure of a single Ethernet interface as long as a redundant Ethernet interface device 530, 540 or 550 remains operational. Similarly, the monitoring instance of the server computer 510 may be configured to only change its operational status from functional to non-functional if all Ethernet devices are disabled. Thus, the effects of a status change are propagated according to the discovered relationships within the monitoring system. If, for example, a single switch port fails, this may lead to a subsequent failure in a network topology, a software component and a business process.

In this or another example, in case one object wants to update its own status, for example, the server computer 510, it may also initiate updating the status of all its dependent objects 520 to 550 as indicated by the downward arrow labeled “CHECK_STATES”. That is, updating states may be based on downward propagation of status requests in a so called “pull” manner rather than on the upwards propagation of status changes in a so called “push” manner.

FIGS. 6A and 6B show different views provided by plug-ins of the enhanced graphical user interface 314. As can be seen, different perspectives of the monitored data center can be easily selected and maintained by the enhanced graphical user interface 314.

In FIGS. 6A and 6B, the structure of the monitored objects is accessible by a topology view 610 which shows a different relationship between the monitored objects. For example, they may be grouped according to different business views, IP subnets, physical locations, platforms. In general, the discovered relationships represent a bidirectional graph. However, for ease of representation, one or several tree views may be used to show different hierarchies discovered in the data center. To discover all related objects, a search can be performed based on the bidirectional graph to select all related objects in the simplified tree view.

FIG. 6A shows a combination of the topology view 610 and a notification view 620. In the notification view 620, status messages associated with the object selected in the topology view 610 are displayed. This view is enabled using event correlation by automatically generated filter rules. For example, based on naming or address information discovered for each object of the data center and stored in the configuration database 342, error messages can be associated with the monitored objects by an automatically configured mapping process.

FIG. 6B shows a combination of the topology view 610 and a properties view 630. In the properties view 630, the properties stored in both the first configuration database 328 (lower part) and second configuration database 342 (upper part) are shown and can be manually updated for a selected object.

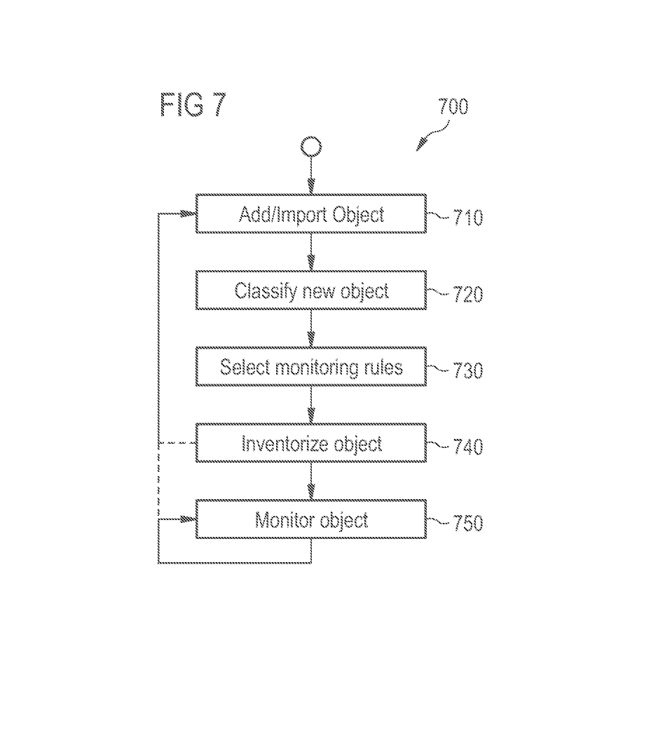

FIG. 7 shows a flowchart of a method 700 for autonomously monitoring a data center.

The method 700 comprises the step 710 of adding or importing objects into a configuration database. For example, as a first step, a reference to a first server may be provided by the import/export function 360. Alternatively, information provided by an earlier system configuration of either the same monitoring system 300 or a conventional monitoring system may be imported into the configuration database 342, by either the import/export function 360 or the synchronization service 370.

In a next step 720, the imported objects are classified based on information provided by an inventory instance 352 associated with each imported object. For example, a type of a server operating system, a number of server applications running or similar information may be detected and used to classify the object as a server computer running a Microsoft Windows or open source Linux operating system, a web, mail, storage or application server, or similar.

In a subsequent step 730, monitoring rules based on best standard values are defined for the classified new object. For example, for a mail server, its availability could be checked by use of the ping interface as well as its response time to requests in accordance with various email protocols such as SMTP, POP3 or IMAP. Similarly, for a storage server, the amount of free storage space available could be monitored and a threshold for a warning could be provided. Furthermore, for an application server, the amount of processing power or CPU utilization may be monitored.

In a step 740, the selected monitoring rules and classification of the added objects is stored in at least one of the configuration database 328 or 342 and may also be synchronized with other monitoring databases used by a monitoring engine. For example, information provided in the second configuration database 342 may be synchronized with the first configuration database 328 such that the detected object and associated monitoring parameters can be monitored by the poll engine 324.

In a step 750, the added object is then monitored according to configuration data included in the configuration database 342 and/or 328. The step 750 of monitoring is performed through the monitoring instances 354 or the conventional check plug-ins 332 at regular intervals or upon occurrence of predefined events, such as system warnings or errors.

As indicated in FIG. 7, during the step 740 of updating the inventory through the inventory instance 352 or the step 750 of monitoring through the monitoring instances 354, further objects related to the monitored or inventoried object may be discovered. These objects are then provided and added to the configuration database 342 in a further step 710 such that the process shown in FIG. 7 is repeated until all components of the monitored data center or a particular subset of interest have been discovered.

Although the apparatus and methods have been described in connection with specific forms thereof, it will be appreciated that a wide variety of equivalents may be substituted for the specified elements described herein without departing from the spirit and scope of this disclosure as described in the appended claims.

What is claimed is:

1. A monitoring system for a data center comprising:
a configuration database that stores configuration information about a plurality of objects provided in the data center;
at least one first inventory instance that adds at least one first object to the configuration database, wherein the first inventory instance classifies the first object based on a set of classification rules to select a set of monitoring rules for the first object based on its classification and to add configuration information about the first object to the configuration database; and
at least one first monitoring instance for status monitoring of the first object, wherein the monitoring instance monitors status of the first object based on respective configuration information stored in the configuration database;
wherein at least one of the first inventory instance and the first monitoring instance identify at least one further object functionally connected to the first object, the further objects added to the configuration database by the first or a second inventory instance and monitored by the first or a second monitoring instance.

2. The system of claim 1, wherein the first inventory instance and the first monitoring instance are provided by at least one plug-in component associated at least with the first object.

3. The system of claim 2, wherein an association between the first objects of the data center to be monitored and the at least one associated plug-in component is stored in the configuration database.

4. The system of claim 2, wherein each one of the objects or each class of objects provided in the data center is associated with at least one respective plug-in component.

5. The system of claim 1, wherein the first monitoring instance associated with the first object propagates a status change of the first object to a second monitoring instance associated with a second object if the first and the second object are functionally connected.

6. The system of claim 5, wherein the second monitoring instance determines a status of the second object based on at least one monitored value of the second object and the propagated status of the first object.

7. The system of claim 6, wherein determination of the status of the second object depends on at least one propagation rule.

8. The system according to claim 1, further comprising:
a user interface that visualizes the objects associated with the configuration information stored in the configuration database based on identified functional connections between the objects.

9. The system according to claim 1, wherein the configuration information for an object comprises at least one selected from the group consisting of a name of the object, a class of the object, at least one monitoring instance associated with the object, at least one monitoring attribute associated with the object, at least one monitoring value associated with the object, at least one status associated with the object and at least one relationship between the object and at least one further object.

10. A method for automatically monitoring a data center comprising:
a) adding at least one first object to a set of objects to be monitored;
b) classifying the at least one first object based on a set of classification rules;
c) selecting a set of monitoring rules for the at least one first object based on its classification;
d) monitoring status of the at least one first object based on the selected set of monitoring rules; and
e) identifying further objects functionally connected to the first object and repeating steps a) to e) for any identified further objects until no further objects are identified.

11. The method of claim 10, wherein identifying further objects connected to the first object comprises identifying a relationship between the first object and at least one further object based on a set of relationship rules.

12. The method of claim 11, further comprising generating a visual representation of the objects to be monitored based on identified relationships between the objects.

13. The method of claim 12, wherein the identified relationship comprises at least one bidirectional relationship and the visual representation comprises at least one graph.

14. The method of claim 12, wherein the identified relationship comprises at least one hierarchical relationship and the visual representation comprises at least one tree.

15. The method of claim 11, wherein, in monitoring, status of the first object depends on status of at least one further object connected to the first object by the identified relationship between the first and at least one further object.

16. The method of claim 15, wherein a status change of the at least one second object is propagated to the first object.

17. The method of claim 10, wherein the set of objects to be monitored are stored in a configuration database.

18. The method of claim 17, wherein relationships between the objects of the set of objects to be monitored indentified based on a set of relationship rules in the step of identifying further objects connected to the first object are stored in the configuration database.

19. The method of claim 10, wherein selecting monitoring rules comprises:
selecting at least one attribute of at least one first object based on its classification; and
providing at least one target value for each selected attribute of the at least one first object based on a set of best practice values.

20. The method of claim 19, further comprising:
providing a visual representation of at least one first object together with the selected at least one attribute and provided at target value, wherein the provided visual representation allows for a change of at least one of the selected at least one attribute and the provided at least one target value.

21. The method of claim 20, wherein a change of at least one of the selected at least one attribute and the provided at least one target value of the first object is propagated to at least one further object based on the identified relationship between the first and the at least one further object.

22. The method of claim 10, wherein monitoring the status of the at least one first object comprises:
providing a visual representation of at least one first object together with a current status value for the at least one first object.
